(19) United States
(12) Patent Application Publication
(10) Pub. No.: US 2026/0179818 A1
(43) Pub. Date: Jun. 25, 2026

(54) SPIN INDUCTOR

(71) Applicant: TDK CORPORATION, Tokyo (JP)

(72) Inventors: Tomoyuki SASAKI, Tokyo (JP); Eiji SUZUKI, Tokyo (JP)

(73) Assignee: TDK CORPORATION, Tokyo (JP)

(21) Appl. No.: 18/850,944

(22) PCT Filed: Jul. 4, 2023
(86) PCT No.: PCT/JP2023/024732

§ 371 Date: Sep. 25, 2024

(51) Int. Cl. H01F 10/32; H01F 27/24

(52) U.S. Cl. CPC H01F 10/324; H01F 27/24

(57) ABSTRACT

This spin inductor includes: a wiring layer; a first ferromagnetic layer which is in contact with a first surface of the wiring layer; and a second ferromagnetic layer which is in contact with a second surface of the wiring layer facing the first surface.

### TECHNICAL FIELD

The present disclosure relates to a spin inductor.

### BACKGROUND ART

An inductor, along with a resistor and a capacitor, is a major electronic component and is used in various electronic devices. A coil is an example of the inductor. There is a trade-off relationship between the size of the coil and the magnitude of the inductance, and it is difficult to achieve a large inductance with a small coil.

In recent years, attention has been focused on a new type of inductor that does not use coils. A new type of inductor that does not use coils is sometimes called an emergent inductor. For example, Patent Document 1, Non-Patent Document 1, and Non-Patent Document 2 disclose a new inductor that uses spin vibration (hereinafter, referred to as a spin inductor). Since the inductance magnitude of the spin inductor becomes larger as the element size becomes smaller, the inductor is attracting attention because both miniaturization and large inductance magnitude can be achieved.

### CITATION LIST

### Patent Document

[Patent Document 1] PCT International Publication No. WO 2022/181069

### Non-Patent Document

[Non-Patent Document 1] Yuta Yamane, Shunsuke Fukami, and Junichi Ieda, Physical Review U.S. Pat. No. 128,147201 (202).
[Non-Patent Document 2] Yasufumi Arai and Jun′ichi leda, Journal of the Physical Society of Japan 92, 074705 (2023).

### SUMMARY OF INVENTION

### Technical Problem

There is a demand for small inductors with large inductance. In order to achieve both of these characteristics, there is a demand for an inductor that exhibits large inductance more efficiently.

The present disclosure has been made in view of the above circumstances and an object thereof is to provide a spin inductor that efficiently exhibits large inductance.

### Solution to Problem

In order to solve the above problems, the present disclosure provides the following means.

(1) A spin inductor according to a first aspect includes a wiring layer, a first ferromagnetic layer which is in contact with a first surface of the wiring layer, and a second ferromagnetic layer which is in contact with a second surface of the wiring layer facing the first surface.

(2) In the spin inductor according to the above-described aspect, the magnetization of the first ferromagnetic layer may be oriented in the opposite direction to the magnetization of the second ferromagnetic layer.

(3) The spin inductor according to the above-described aspect may further include a third ferromagnetic layer and a magnetic coupling layer. The magnetic coupling layer is between the second ferromagnetic layer and the third ferromagnetic layer.

(4) In the spin inductor according to the above-described aspect, the magnetization of the first ferromagnetic layer may be oriented in the same direction of the magnetization of the third ferromagnetic layer.

(5) In the spin inductor according to the above-described aspect, the film thickness of the third ferromagnetic layer may be thicker than the film thickness of the second ferromagnetic layer.

(6) In the spin inductor according to the above-described aspect, the wiring layer may have a laminated structure in which a first layer and a second layer are laminated.

(7) In the spin inductor according to the above-described aspect, the sign of the spin current generated in the first layer may be different from the sign of the spin current generated in the second layer.

(8) In the spin inductor according to the above-described aspect, the magnetization of the first ferromagnetic layer may be oriented in the same direction as the magnetization of the second ferromagnetic layer.

(9) The spin inductor according to the above-described aspect may further include a magnetic shield layer. The magnetic shield layer is separated from the first ferromagnetic layer and the second ferromagnetic layer in the laminating direction.

(10) In the spin inductor according to the above-described aspect, the wiring layer may be configured to inject spins into the first ferromagnetic layer and the second ferromagnetic layer, and the magnetizations of the first ferromagnetic layer and the second ferromagnetic layer may be configured to precess by the injected spins.

### BRIEF DESCRIPTION OF DRAWINGS

FIG. 1 is a perspective view of a spin inductor according to a first embodiment.

FIG. 2 is a cross-sectional view of the spin inductor according to the first embodiment.

FIG. 3 is a plan view of the spin inductor according to the first embodiment.

FIG. 4 is a schematic view illustrating the function of the spin inductor according to the first embodiment.

FIG. 5 is a diagram illustrating a method of manufacturing the spin inductor according to the first embodiment.

FIG. 6 is a diagram illustrating a method of manufacturing the spin inductor according to the first embodiment.

FIG. 7 is a diagram illustrating a method of manufacturing the spin inductor according to the first embodiment.

FIG. 8 is a cross-sectional view of a spin inductor according to a second embodiment.

FIG. 9 is a cross-sectional view of a spin inductor according to a third embodiment.

FIG. 10 is a schematic view illustrating the function of the spin inductor according to the third embodiment.

FIG. 11 is a perspective view of a spin inductor according to a fourth embodiment.

FIG. 12 is a cross-sectional view of the spin inductor according to the fourth embodiment.

FIG. 13 is a plan view of the spin inductor according to the fourth embodiment.

FIG. 14 is an application example of the spin inductor according to this embodiment.

### DESCRIPTION OF EMBODIMENTS

Hereinafter, this embodiment will be described in detail with reference to the drawings. The drawings used in the following description may show characteristic parts in an enlarged scale for the sake of convenience in order to make the characteristics easier to understand, and the dimensional ratios of each component may differ from the actual ones. The materials, dimensions, and the like exemplified in the following description are merely examples, and the present disclosure is not limited to them. They can be modified as appropriate within the scope of the effects of the present disclosure.

First, directions will be defined. A direction in which each layer extends is defined as the x direction, and the direction perpendicular to the x direction is defined as the y direction. For example, the first direction connecting a first terminal 20 and a second terminal 30 is defined as the x direction. The second direction perpendicular to the first direction is defined as, for example, the y direction. Further, the thickness direction of each layer is defined as the z direction. The z direction is perpendicular to the x direction and the y direction.

### First Embodiment

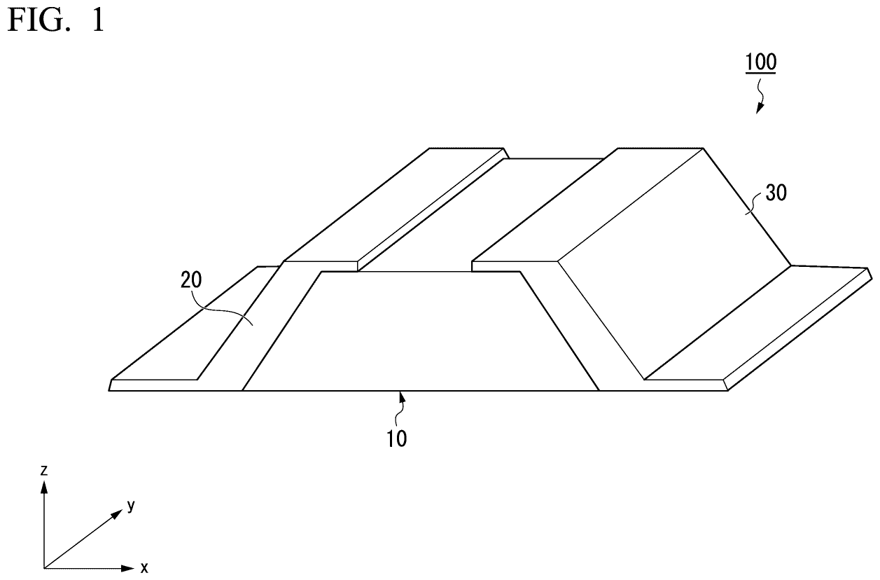

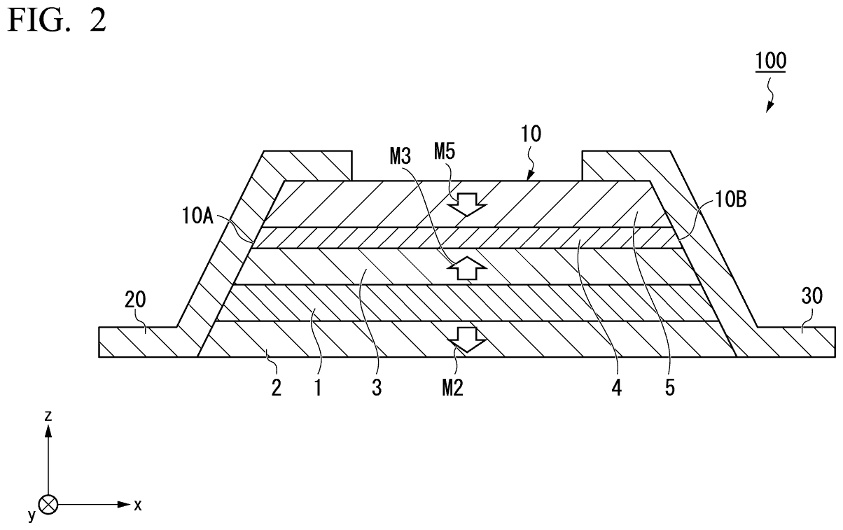

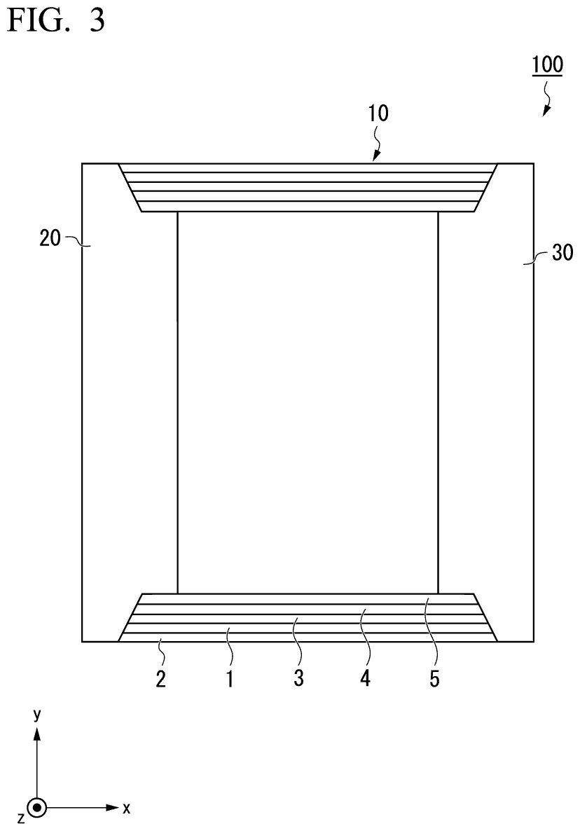

FIG. 1 is a perspective view of a spin inductor 100 according to a first embodiment. FIG. 2 is a cross-sectional view of the spin inductor 100 according to the first embodiment. FIG. 3 is a plan view of the spin inductor 100 according to the first embodiment.

The spin inductor 100 is an inductor that operates by vibration of magnetization in a magnetic material. The spin inductor 100 cuts the high-frequency components of the current and passes the constant components of the current. The current flows between the first terminal 20 and the second terminal 30. The spin inductor 100 is disposed in a portion where it is desired to cut off high frequency current. High-frequency current is cut by the spin inductor 100, but direct current flows through the spin inductor 100. For the direct current, the spin inductor 100 is a resistor.

The spin inductor 100 includes a laminate 10, a first terminal 20, and a second terminal 30.

The first terminal 20 is in contact with a first side surface 10A of the laminate 10. The first terminal 20 is in contact with a wiring layer 1, a first ferromagnetic layer 2, and a second ferromagnetic layer 3 of the laminate 10. The first terminal 20 may be in contact with a third ferromagnetic layer 5. The first side surface 10A is inclined with respect to the z direction. The first side surface 10A is inclined with respect to the yz plane.

The first terminal 20 is a conductor. The current flows from the first terminal 20 to the laminate 10. The laminate 10 is a laminate in which thin films are laminated. Since the first side surface 10A is inclined, the contact area between the thin film constituting the laminate 10 and the first terminal 20 is increased, and the electrical connection between the thin film constituting the laminate 10 and the first terminal 20 is stabilized.

The second terminal 30 is in contact with a second side surface 10B of the laminate 10. The second side surface 10B is a side surface different from the first side surface 10A of the laminate 10. The second side surface 10B is, for example, a side surface opposite to the first side surface 10A in the x direction. The second terminal 30 is in contact with the wiring layer 1, the first ferromagnetic layer 2, and the second ferromagnetic layer 3 of the laminate 10. The second terminal 30 may be in contact with the third ferromagnetic layer 5. The second side surface 10B is inclined with respect to the z direction. The second side surface 10B is inclined with respect to the yz plane.

The second terminal 30 is a conductor. The current flows from the laminate 10 to the second terminal 30. Since the second side surface 10B is inclined, the contact area between the thin film constituting the laminate 10 and the second terminal 30 is increased, and the electrical connection between the thin film constituting the laminate 10 and the second terminal 30 is stabilized.

Here, although an example has been shown in which the first terminal 20 and the second terminal 30 are formed on the side surface of the laminate 10, the first terminal 20 and the second terminal 30 are not limited to this example. For example, the first terminal 20 and the second terminal 30 may be connected to the upper surface or the lower surface of the laminate 10. In this case, the via wiring that is in contact with the laminate 10 and extends in the z direction becomes the first terminal 20 and the second terminal 30.

The laminate 10 includes the wiring layer 1, the first ferromagnetic layer 2, the second ferromagnetic layer 3, a magnetic coupling layer 4, and the third ferromagnetic layer 5. The laminate 10 may have a plurality of units each including the wiring layer 1, the first ferromagnetic layer 2, the second ferromagnetic layer 3, the magnetic coupling layer 4, and the third ferromagnetic layer 5. For example, a spacer layer is interposed between adjacent units. The spacer layer may be a conductor, a semiconductor, or an insulator.

For example, the length of the wiring layer 1 in the x direction is shorter than the length in the y direction. For example, the length of the laminate 10 in the x direction is shorter than the length in the y direction. If the length of the wiring layer 1 in the y direction is long, the current density of the current flowing through the wiring layer 1 becomes small. Furthermore, if the length of the wiring layer 1 in the x direction is short, the resistance of the spin inductor 100 becomes low.

The wiring layer 1 includes any one of a metal, an alloy, an intermetallic compound, a metal boride, a metal carbide, a metal silicide, and a metal phosphide, which has a function of generating a spin current by the spin Hall effect when a current flows. The wiring layer 1 may be called a spin-orbit torque wiring.

The wiring layer 1 includes, for example, a non-magnetic heavy metal as a main component. Heavy metals refer to metals with a specific gravity equal to or greater than that of yttrium (Y). Non-magnetic heavy metals are, for example, non-magnetic metals with a large atomic number of 39 or more that have d electrons or f electrons in their outermost shell. The wiring layer 1 is made of, for example, Hf, Ta, or W. Non-magnetic heavy metals occure stronger spin-orbit interactions than other metals. The spin Hall effect is caused by the spin-orbit interaction. When spins tend to be unevenly distributed in the wiring layer 1 due to the spin Hall effect, a spin current J_{S} tends to be generated.

The wiring layer 1 may further include a magnetic metal. The magnetic metal is a ferromagnetic metal or an antiferromagnetic metal. Small amounts of magnetic metal contained in a non-magnetic material act as a scattering factor for spins. The small amount is, for example, 3% or less of the total molar ratio of the elements constituting the wiring layer. When spins are scattered by a magnetic metal, the spin-orbit interaction is enhanced, and the efficiency of generating a spin current relative to a current is increased.

The wiring layer 1 may include a topological insulator. The topological insulator is a material in which the interior is an insulator or highly resistive material, but a spin-polarized metallic state exists on the surface. The topological insulator has an internal magnetic field due to the spin-orbit interaction. The topological insulator exhibits a new topological phase due to the effect of the spin-orbit interaction even in the absence of an external magnetic field. The topological insulator can generate a pure spin current highly efficiently due to strong spin-orbit coupling and broken inversion symmetry at the edges. Further, since a current flows only on the surface of the topological insulator, a high current density can be achieved with a small amount of current.

Examples of the topological insulator are Sn, SnTe, Bi_{1.5}Sb_{0.5}Te_{1.7}Se_{1.3}, TlBiSe₂, Bi₂Te₃, Bi₁₋ₓSbₓ, (Bi₁₋ₓSbₓ)₂Te₃, and the like. The topological insulator is capable of generating a spin current with high efficiency.

The first ferromagnetic layer 2 is in contact with a first surface 1A of the wiring layer 1. The first ferromagnetic layer 2 is in contact with, for example, the lower surface of the wiring layer 1.

The first ferromagnetic layer 2 is a ferromagnetic material. The ferromagnetic material is, for example, a metal selected from the group consisting of Cr, Mn, Co, Fe, and Ni, an alloy containing one or more of these metals, or an alloy containing these metals and at least one or more elements selected from the group consisting of B, C, and N.

The ferromagnetic material is, for example, Co—Fe, Co—Fe—B, Ni—Fe, Co—Ho alloy, Sm—Fe alloy, Fe—Pt alloy, Co—Pt alloy, or CoCrPt alloy. A CoCrPt alloy and an L1₀ type CoFe alloy have large saturation magnetization and strong magnetic anisotropy, and when these are used for the first ferromagnetic layer 2, the resonant frequency of the spin inductor 100 becomes high.

Further, the first ferromagnetic layer 2 may also be a magnetic insulator. When the first ferromagnetic layer 2 is a magnetic insulator, it is particularly preferable that the wiring layer 1 is a topological insulator. Since the current flows only at the bonding surface between the magnetic insulator and the topological insulator, current loss is reduced, and energy loss due to heat generation and the like can be suppressed.

Further, the first ferromagnetic layer 2 may also be a ferrimagnetic insulator or an antiferromagnetic insulator. When the first ferromagnetic layer 2 is an antiferromagnetic insulator, it is particularly preferable that the wiring layer 1 is a topological insulator. Since the current flows only at the bonding surface between the antiferromagnetic insulator and the topological insulator, current loss is reduced, and energy loss due to heat generation and the like can be suppressed. Furthermore, when the first ferromagnetic layer 2 is an antiferromagnetic insulator, the resonance frequency of the first ferromagnetic layer 2 becomes high and no resonance occurs even in the high frequency region of 10 GHz or more. Therefore, a spin inductor in which the first ferromagnetic layer 2 is an antiferromagnetic insulator can exhibit stable inductance over a wide band. For example, antiferromagnetic insulators include oxides containing magnetic elements such as NiO, MnO, Cr₂O₃, ferrite and garnet, sulfides containing magnetic elements such as MnS, and chlorides containing magnetic elements such as FeCl₂.

The second ferromagnetic layer 3 is in contact with a second surface 1B of the wiring layer 1, The second surface 1B is a surface of the wiring layer 1 that faces the first surface 1A. The second ferromagnetic layer 3 covers, for example, the entire upper surface of the wiring layer 1.

The second ferromagnetic layer 3 includes the same material as the first ferromagnetic layer 2. The second ferromagnetic layer 3 may include the same material as the first ferromagnetic layer 2, or may include a different material.

The magnetization M2 of the first ferromagnetic layer 2 and the magnetization M3 of the second ferromagnetic layer 3 are oriented in opposite directions when no current flows through the wiring layer 1 and no external magnetic field is applied (hereinafter, referred to as the initial state). Here, “no current flows” means a state in which no potential difference is applied to the wiring layer 1. Moreover, “no external magnetic field is applied” means a state in which no magnetic field is intentionally applied to the first ferromagnetic layer 2 and the second ferromagnetic layer 3. The magnetization M2 of the first ferromagnetic layer 2 is oriented in the opposite direction to the magnetization M3 of the second ferromagnetic layer 3 in the initial state. In the example shown in FIG. 2, the magnetization M2 is oriented in the −z direction, and the magnetization M3 is oriented in the +z direction, but the relationship between them may be reversed. Furthermore, the magnetization M2 and the magnetization M3 may be oriented in any direction within the xy plane, or in a direction inclined from the xy plane toward the z direction.

The magnetic coupling layer 4 is, for example, between the second ferromagnetic layer 3 and the third ferromagnetic layer 5. The magnetic coupling layer 4 is a layer that does not inhibit the magnetic coupling between the second ferromagnetic layer 3 and the third ferromagnetic layer 5.

The magnetic coupling layer 4 includes at least one selected from the group consisting of, for example, Ru, Ir, and Rh. The magnetic coupling layer 4 is, for example, a metal film of Ru, Ir, or Rh.

For example, the second ferromagnetic layer 3 and the third ferromagnetic layer 5 are antiferromagnetically coupled with the magnetic coupling layer 4 interposed therebetween. In this case, the second ferromagnetic layer 3, the magnetic coupling layer 4, and the third ferromagnetic layer 5 form a synthetic antiferromagnetic structure (SAF structure). By antiferromagnetically coupling the second ferromagnetic layer 3 and the third ferromagnetic layer 5, the coercive force of the second ferromagnetic layer 3 becomes larger than when the third ferromagnetic layer 5 is not present, and a coercive force difference can be created between the first ferromagnetic layer 2 and the second ferromagnetic layer 3.

The second ferromagnetic layer 3 and the third ferromagnetic layer 5 may be ferromagnetically coupled with the magnetic coupling layer 4 interposed therebetween.

The third ferromagnetic layer 5 is located at a position facing the second ferromagnetic layer 3 with the magnetic coupling layer 4 interposed therebetween. The third ferromagnetic layer 5 includes the same material as the first ferromagnetic layer 2. The third ferromagnetic layer 5 may include the same material as the first ferromagnetic layer 2, or may include a different material.

In the initial state, the magnetization M5 of the third ferromagnetic layer 5 is oriented in the same direction as the magnetization M2 of the first ferromagnetic layer 2. In the initial state, the magnetization M5 of the third ferromagnetic layer 5 may be oriented in the opposite direction to the magnetization M3 of the second ferromagnetic layer 3. In the example shown in FIG. 2, although an example has been shown in which magnetization M5 is oriented in the −z direction, the magnetization M5 may be oriented in the +z direction, or in any direction within the xy plane, or in a direction inclined from the xy plane toward the z direction.

The film thickness of the third ferromagnetic layer 5 in the z direction is thicker than, for example, the film thickness of the second ferromagnetic layer 3 in the z direction. Since the film thickness of the third ferromagnetic layer 5 is thicker than the film thickness of the second ferromagnetic layer 3, it becomes easier to make the magnetization of the first ferromagnetic layer 2 and the magnetization of the second ferromagnetic layer 3 oriented in opposite directions when manufacturing the spin inductor 100.

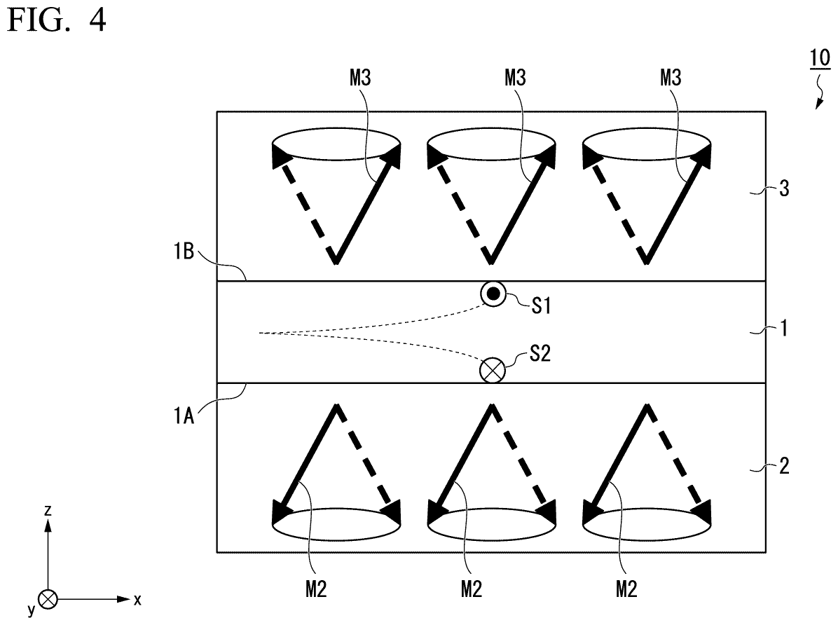

Next, the function of the spin inductor 100 will be described. FIG. 4 is a schematic view illustrating the function of the spin inductor 100.

The spin inductor 100 functions as an inductor when a current flows along the wiring layer 1. When a current is applied between the first terminal 20 and the second terminal 30, the current flows within the plane of the wiring layer 1.

The current flowing through the wiring layer 1 generates a spin current due to the spin Hall effect.

The spin Hall effect is a phenomenon in which a spin current is induced in a direction perpendicular to the direction of the flow of current (for example, the z direction) due to spin-orbit interaction when the current flows. The spin Hall effect is similar to the normal Hall effect in that the moving direction of moving charges (electrons) can be bent. In the normal Hall effect, the moving direction of charged particles moving within a magnetic field is bent by the Lorentz force. In contrast, in the spin Hall effect, the moving direction of spin is bent simply by the movement of electrons (the flow of current) even in the absence of the magnetic field.

For example, when a current flows in the x direction of the wiring layer 1, for example, spins S1 polarized in the −y direction are bent in the +z direction relative to the travel direction, and spins S2 polarized in the +y direction are bent in the −z direction relative to the travel direction.

The spins S2 are injected from the first surface 1A into the adjacent second ferromagnetic layer 3. The spins S1 are injected from the second surface 1B into the adjacent first ferromagnetic layer 2. Since the distance between the wiring layer 1 and the first ferromagnetic layer 2 is equal to or shorter than the spin diffusion length of the spins S2, the spins S2 generated by the wiring layer 1 can be efficiently injected into the first ferromagnetic layer 2. Further, since the distance between the wiring layer 1 and the second ferromagnetic layer 3 is equal to or shorter than the spin diffusion length of the spins S1, the spins S1 generated in the wiring layer 1 can be efficiently injected into the second ferromagnetic layer 3.

The magnetization M2 of the first ferromagnetic layer 2 precesses due to the spins S2 injected from the wiring layer 1. The coercive force of the magnetization M2 and the magnitude of the current flowing through the wiring layer 1 are adjusted so that the magnetization M2 precesses without being reversed by the injected spins S2.

The magnetization M3 of the second ferromagnetic layer 3 precesses due to the spins S1 injected from the wiring layer 1. The coercive force of the magnetization M3 and the magnitude of the current flowing through the wiring layer 1 are adjusted so that the magnetization M3 precesses without being reversed by the injected spins $1.

When the magnetization M2 of the first ferromagnetic layer 2 and the magnetization M3 of the second ferromagnetic layer 3 precess, energy conversion occurs between the magnetic moment and the current, and the spin inductor 100 exhibits an inductor function. When the first ferromagnetic layer 2 and the second ferromagnetic layer 3 are magnetic insulators, localized spins contained in the magnetic insulators precess, and energy conversion occurs between the spin waves propagating due to the vibration of the spins and the current, so that the spin inductor 100 exhibits an inductor function.

From the viewpoint of maintaining the precession of the magnetization M2 and the magnetization M3, the magnetization M2 and the magnetization M3 preferably have a component oriented in the z direction, and more preferably are oriented in the z direction in the initial state. When the magnetization M2 and the magnetization M3 are oriented in the x direction or the y direction, magnetization reversal may occur and the magnetization precession may not be maintained even when no external magnetic field is applied. When the magnetization M2 and the magnetization M3 are oriented in the z direction, magnetization reversal is difficult to occur in the absence of the magnetic field. Since the spin inductor 100 exhibits an inductor function by using energy conversion between a magnetic moment and a current, the inductor function is not fully exhibited when the precession of magnetization stops.

Furthermore, even when the magnetization M2 and the magnetization M3 are oriented in the x direction or the y direction, it is possible to maintain the precession of the magnetization by adjusting the current density flowing through the wiring layer 1.

Since the spin inductor 100 generates a resonance phenomenon at the frequency of the ferromagnetic resonance of the first ferromagnetic layer 2 and the second ferromagnetic layer 3, it is difficult for the spin inductor 100 to stably operate as an inductor near the resonance frequency. Therefore, the spin inductor 100 is used at a frequency sufficiently lower or sufficiently higher than the ferromagnetic resonance frequency of the spin inductor 100. The sufficiently low frequency or sufficiently high frequency generally indicates a frequency that is deviated from the ferromagnetic resonance frequency by 5% or more based on ferromagnetic resonance frequency. The spin inductor 100 is capable of generating inductance even at frequencies exceeding, for example, 10 GHz or THz. Furthermore, the inductance generated by the spin inductor 100 is sufficient even if it is 1 nH or less.

Further, the magnetization M5 of the third ferromagnetic layer 5 that is antiferromagnetically coupled to the second ferromagnetic layer 3 may precess together with the magnetization M3 of the second ferromagnetic layer 3. When the magnetization M5 of the third ferromagnetic layer 5 precesses, the spin inductor 100 exhibits a larger inductance. Furthermore, when the precession period of the magnetization M5 of the third ferromagnetic layer 5 is different from the precession period of the magnetization M2 of the first ferromagnetic layer 2 and the magnetization M3 of the second ferromagnetic layer 3, the spin inductor 100 exhibits an inductor function for a wider band of high-frequency currents.

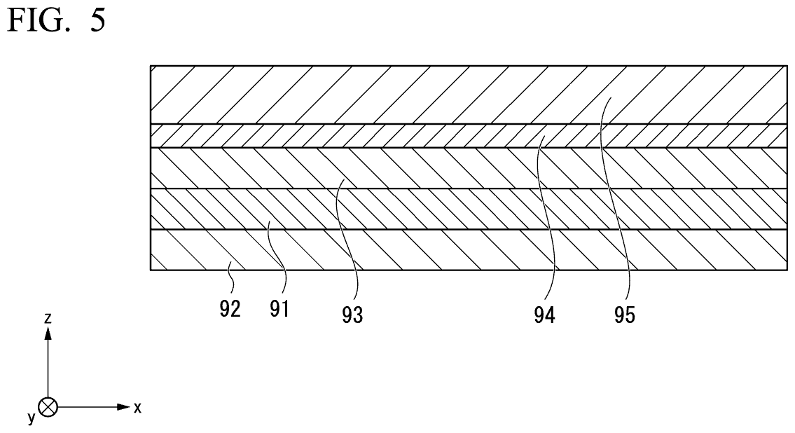

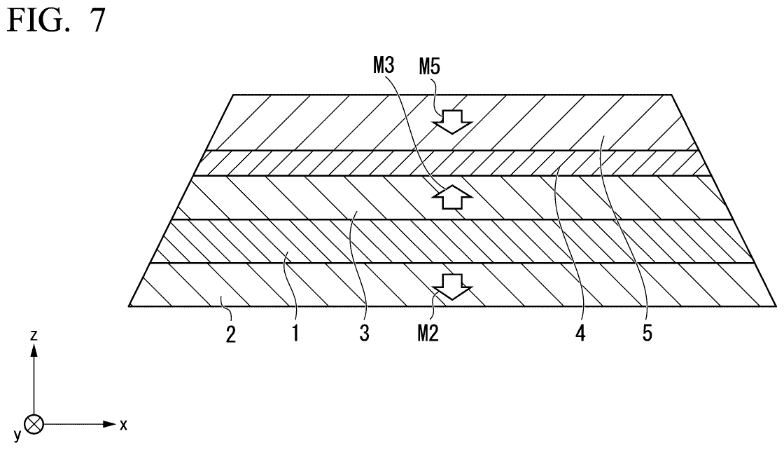

Next, a method of manufacturing the spin inductor 100 according to this embodiment will be described. FIGS. 5 and 7 are schematic views illustrating a method of manufacturing the spin inductor according to this embodiment.

First, as shown in FIG. 5, a ferromagnetic layer 92, a conductive layer 91, a ferromagnetic layer 93, an intermediate layer 94, and a ferromagnetic layer 95 are sequentially laminated. The layers can be formed by, for example, sputtering, chemical vapor deposition (CVD), electron beam deposition (EB deposition), atomic laser deposition, or the like.

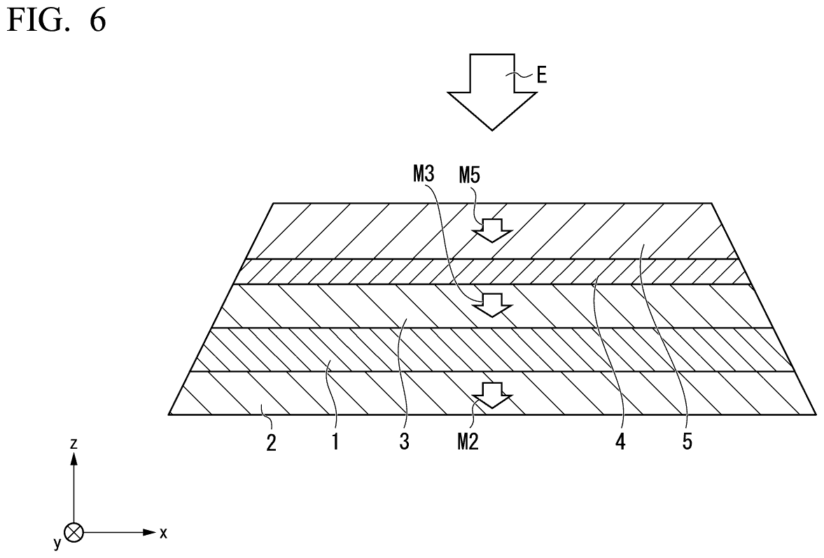

Next, as shown in FIG. 6, the laminate is processed into a predetermined shape. Each layer can be processed using, for example, photolithography. By this precession, the ferromagnetic layer 92 becomes the first ferromagnetic layer 2, the conductive layer 91 becomes the wiring layer 1, the ferromagnetic layer 93 becomes the second ferromagnetic layer 3, the intermediate layer 94 becomes the magnetic coupling layer 4, and the ferromagnetic layer 95 becomes the third ferromagnetic layer 5.

Further, as shown in FIG. 6, an external magnetic field E is applied to the laminate. The external magnetic field E may be applied to the laminate after precession or before precession. The strength of the external magnetic field E is set so that the magnetization of each layer is sufficiently oriented in the direction of the applied magnetic field. The magnetization M2 of the first ferromagnetic layer 2, the magnetization M3 of the second ferromagnetic layer 3, and the magnetization M5 of the third ferromagnetic layer 5 are oriented in the direction in which the external magnetic field E is applied.

Next, as shown in FIG. 7, the application of the external magnetic field E to the laminate is stopped. The second ferromagnetic layer 3 is antiferromagnetically coupled to the third ferromagnetic layer 5 with the magnetic coupling layer 4 interposed therebetween. Therefore, the magnetization M3 of the second ferromagnetic layer 3, which has a smaller coercive force than the third ferromagnetic layer 5, is reversed when the application of the external magnetic field Eis stopped. The magnetization M3 of the second ferromagnetic layer 3 is antiparallel to the magnetization M5 of the third ferromagnetic layer 5.

Next, a conductive layer is applied to cover the laminate 10 produced in FIG. 7. Then, the central portion of the conductive layer in the x direction is removed to form the first terminal 20 and the second terminal 30. By using this procedure, the spin inductor 100 according to this embodiment can be produced.

As described above, in the spin inductor 100 according to this embodiment, the magnetization M2 of the first ferromagnetic layer 2 and the magnetization M3 of the second ferromagnetic layer 3 precess due to the spins injected from the wiring layer 1. Since energy conversion occurs between the magnetic moments of the precessing magnetizations M2 and M3 and the current, the spin inductor 100 functions as an inductor. Furthermore, since the spin inductor according to this embodiment uses both spins generated from both sides of the wiring layer 1, the spin inductor exhibits a large inductance compared to a case in which spins generated from only one side are used.

Further, since the spin inductor according to this embodiment exhibits an inductor function by using energy conversion between current and magnetic moment, the spin inductor can exhibit strong inductance even in a small size. For example, even if the maximum width of the laminate 10 when viewed in plan view from the z direction is 0.003 mm or less, an inductance of 0.1 μH or more and 10 μH or less can be achieved. Small inductance elements are particularly in demand in areas where it is difficult to incorporate large elements, such as in space and at cryogenic temperatures. Furthermore, even if the maximum width of the spin inductor 10 in plan view from the z direction is several tens of nm and the length is several hundreds of nm, the spin inductor 100 exhibits an inductance of several nH to several hundreds of nH.

### Second Embodiment

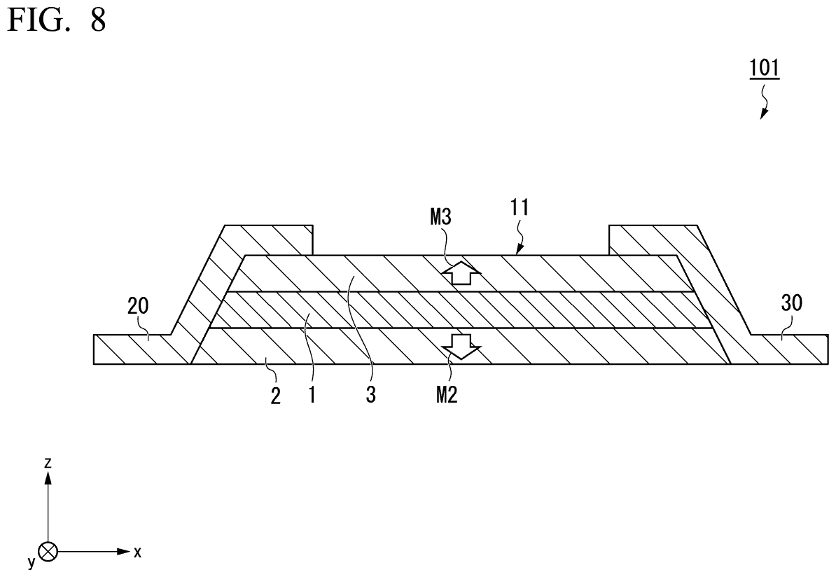

FIG. 8 is a cross-sectional view of a spin inductor 101 according to a second embodiment. In the spin inductor 101 according to the second embodiment, the same components as those in the spin inductor 100 according to the first embodiment are designated by the same reference numerals, and the description thereof will be omitted.

The spin inductor 101 according to the second embodiment includes a laminate 11, the first terminal 20, and the second terminal 30. The laminate 11 includes the wiring layer 1, the first ferromagnetic layer 2, and the second ferromagnetic layer 3. The laminate 11 is different from the laminate 10 in that the magnetic coupling layer 4 and the third ferromagnetic layer 5 are not provided.

The spin inductor 101 according to the second embodiment can be produced in the same procedure as the spin inductor 100 according to the first embodiment. The magnetization directions of the magnetizations M2 and M3 can be controlled by using the difference in coercive force between the second ferromagnetic layer 3 and the third ferromagnetic layer 5. For example, the magnetization directions of the magnetization M2 and the magnetization M3 can be controlled by applying an external magnetic field in a first direction and then applying an external magnetic field in a second direction opposite to the first direction with a strength such that the magnetization of only one of the second ferromagnetic layer 3 and the third ferromagnetic layer 5 is reversed.

Since the spin inductor 101 according to the second embodiment uses both spins generated from both sides of the wiring layer 1, the spin inductor exhibits a large inductance compared to a case in which spins generated from only one side are used.

### Third Embodiment

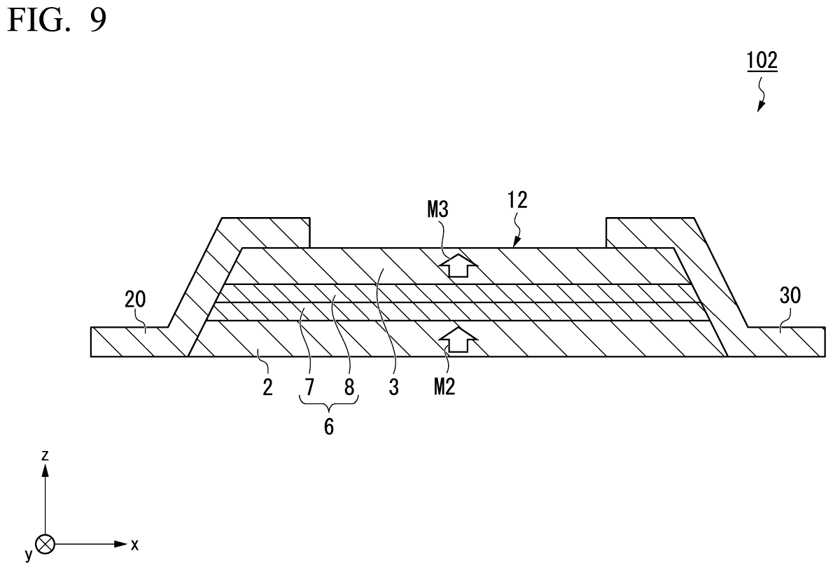

FIG. 9 is a cross-sectional view of a spin inductor 102 according to a third embodiment. In the spin inductor 102 according to the third embodiment, the same components as those in the spin inductor 100 according to the first embodiment are designated by the same reference numerals, and the description thereof will be omitted.

The spin inductor 102 according to the third embodiment includes a laminate 12, the first terminal 20, and the second terminal 30. The laminate 12 includes a wiring layer 6, the first ferromagnetic layer 2, and the second ferromagnetic layer 3. The laminate 12 is different from the laminate 10 in that the magnetic coupling layer 4 and the third ferromagnetic layer 5 are not provided and the wiring layer 6 has a different configuration. Further, in the laminate 12, the magnetization M2 of the first ferromagnetic layer 2 and the magnetization M3 of the second ferromagnetic layer 3 are oriented in the same direction in the initial state.

The wiring layer 6 has a laminated structure in which a first layer 7 and a second layer 8 are laminated. The first layer 7 is in contact with the first ferromagnetic layer 2. The second layer 8 is in contact with the second ferromagnetic layer 3. The wiring layer 6 may further include a layer other than the first layer 7 and the second layer 8.

The first layer 7 and the second layer 8 each include any one of a metal, an alloy, an intermetallic compound, a metal boride, a metal carbide, a metal silicide, and a metal phosphide that has a function of generating a spin current by the spin Hall effect when a current flows. The first layer 7 and the second layer 8 can be made of the same material as the wiring layer 1.

The first layer 7 injects spins generated in the first layer 7 by the spin Hall effect into the first ferromagnetic layer 2. The second layer 8 injects spins generated in the second layer 8 by the spin Hall effect into the second ferromagnetic layer 3. The sign of the spin current generated in the first layer 7 and the sign of the spin current generated in the second layer 8 are, for example, different from each other.

The sign of the spin current indicates the surface and direction in which polarized spins are accumulated when a current flows in the x direction of the wiring layer 6. For example, if the sign of the spin current when the spins S1 polarized in the −y direction are accumulated on the first surface and the spins S2 polarized in the +y direction are accumulated on the second surface is taken as “positive”, the spins $1 polarized in the +y direction are accumulated on the first surface, and when the spins S2 polarized in the −y direction are accumulated on the second surface, the sign of the spin current becomes “negative.”

For example, the first layer 7 and the second layer 8 have spin Hall angles with different polarities. When the “polarity of the spin Hall angle” is different, the first spins S1 are bent in the z direction or the −z direction, and the sign of the spin current is different. The polarity of the spin Hall angle of the first layer 7 and the second layer 8 can be changed by selecting the materials constituting the first layer 7 and the second layer 8. For example, when the layer mainly includes a metal element belonging to any one of groups 8, 9, 10, 11, and 12, the spin Hall angle of the layer often exhibits a positive polarity. Furthermore, when the layer mainly includes a metal element belonging to any one of groups 3, 4, 5, and 6, the spin Hall angle of the layer often exhibits a negative polarity. Furthermore, the polarity of the spin Hall angle is determined not only by the material constituting the layer, but also by the thickness of the layer and the like.

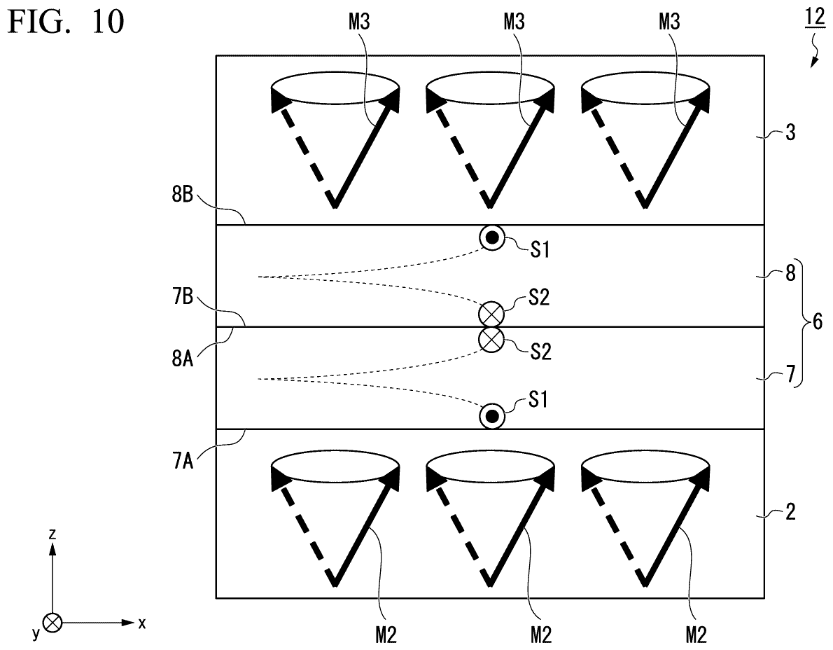

Next, the function of the spin inductor 102 will now be described. FIG. 10 is a schematic view illustrating the function of the spin inductor 102.

The spin inductor 102 functions as an inductor when a current flows along the wiring layer 6. When a current is applied between the first terminal 20 and the second terminal 30, the current flows within the plane of the wiring layer 6.

The wiring layer 6 includes the first layer 7 and the second layer 8. A current also flows in the x direction inside each of the first layer 7 and the second layer 8. The current flowing through the first layer 7 and the second layer 8 generates a spin current due to the spin Hall effect.

The first layer 7 and the second layer 8 have spin currents with different signs generated therein. In the first layer 7, the spins S1 polarized in the −y direction are bent in the −z direction relative to the travel direction, and the spins S2 polarized in the +y direction are bent in the +z direction relative to the travel direction. In contrast, in the second layer 8, the spins S1 polarized in the −y direction are bent in the +z direction relative to the travel direction, and the spins S2 polarized in the +y direction are bent in the −z direction relative to the travel direction.

The spins S1 stored in the first surface 7A are injected from the first surface 7A into the adjacent first ferromagnetic layer 2. The spins S1 stored in the second surface 8B are injected from the second surface 8B into the adjacent second ferromagnetic layer 3. The spins S1 polarized in the same direction are injected into the first ferromagnetic layer 2 and the second ferromagnetic layer 3. Therefore, in the initial state, the magnetization M2 of the first ferromagnetic layer 2 and the magnetization M3 of the second ferromagnetic layer 3 are preferably oriented in the same direction.

Since the distance between the first layer 7 and the first ferromagnetic layer 2 is equal to or shorter than the spin diffusion length of the spins S1, the spins S1 generated by the first layer 7 can be efficiently injected into the first ferromagnetic layer 2. Further, since the distance between the second layer 8 and the second ferromagnetic layer 3 is equal to or shorter than the spin diffusion length of the spins S1, the spins S1 generated by the second layer 8 can be efficiently injected into the second ferromagnetic layer 3.

The magnetization M2 of the first ferromagnetic layer 2 precesses due to the spins S1 injected from the first layer 7. The coercive force of the magnetization M2 and the magnitude of the current flowing through the wiring layer 6 are adjusted so that the magnetization M2 precesses without being reversed by the injected spins S1.

The magnetization M3 of the second ferromagnetic layer 3 precesses due to the spins S1 injected from the second layer 8. The coercive force of the magnetization M3 and the magnitude of the current flowing through the wiring layer 6 are adjusted so that the magnetization M3 precesses without being reversed by the injected spins $1.

When the magnetization M2 of the first ferromagnetic layer 2 and the magnetization M3 of the second ferromagnetic layer 3 precess, energy conversion occurs between the magnetic moment and the current, and the spin inductor 102 exhibits an inductor function.

As described above, the spin inductor 102 according to the third embodiment exhibits a large inductance since spins injected from both sides of the wiring layer 6 into the adjacent ferromagnetic layers are used.

Further, although an example has been shown so far in which the magnetization M2 of the first ferromagnetic layer 2 and the magnetization M3 of the second ferromagnetic layer 3 are oriented in the same direction in the initial state and the sign of the spin current generated by the first layer 7 and the sign of the spin current generated by the second layer 8 are different, the configuration of the laminate 12 is not limited to this example. For example, in the initial state, the magnetization M2 of the first ferromagnetic layer 2 and the magnetization M3 of the second ferromagnetic layer 3 may be oriented in the opposite directions and the sign of the spin current generated by the first layer 7 and the sign of the spin current generated by the second layer 8 may be the same.

### Fourth Embodiment

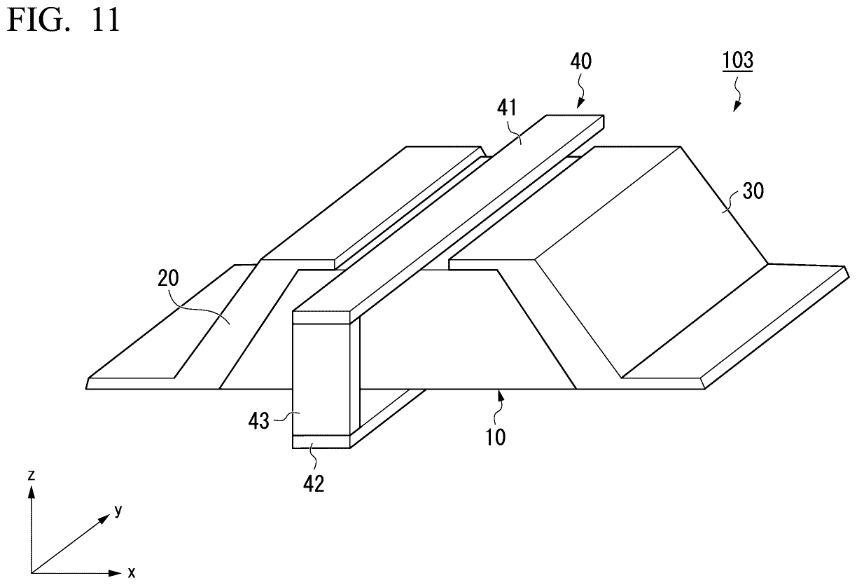

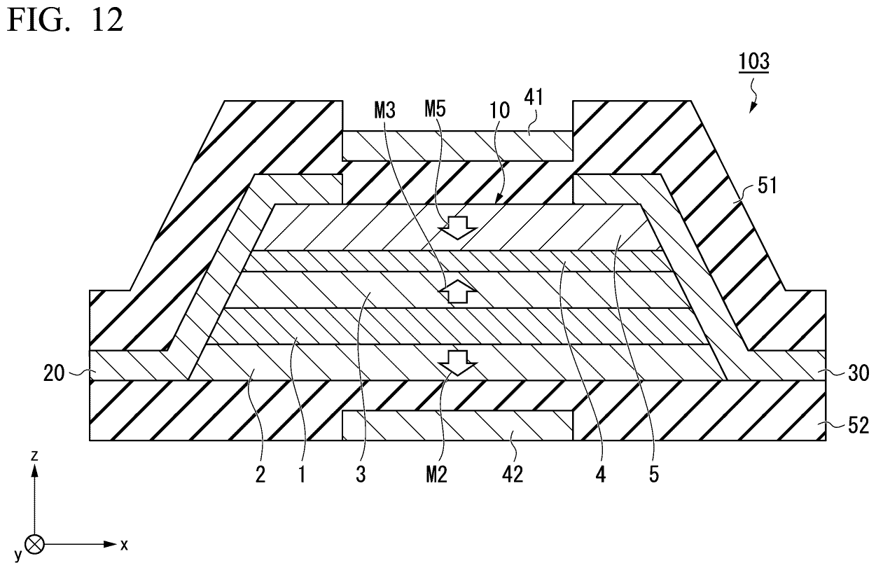

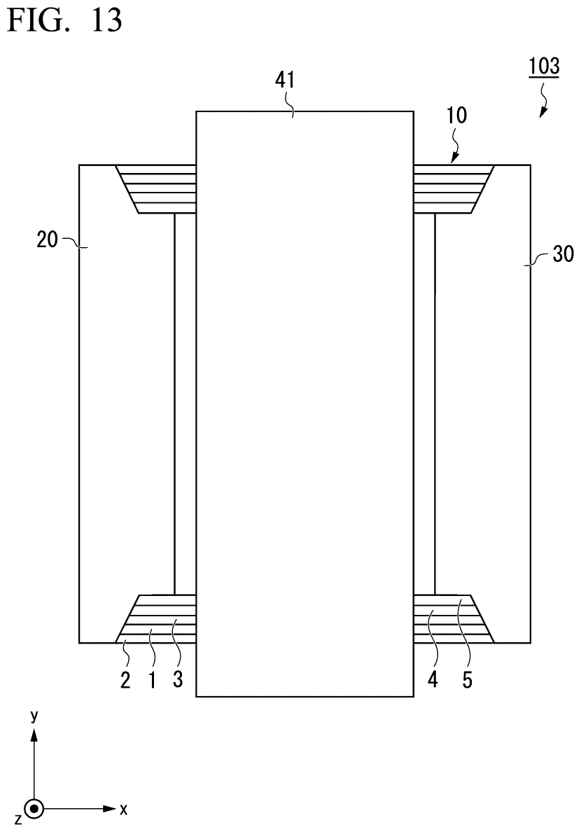

FIG. 11 is a perspective view of a spin inductor 103 according to a fourth embodiment. FIG. 12 is a cross-sectional view of the spin inductor 103 according to the fourth embodiment. FIG. 13 is a plan view of the spin inductor 103 according to the fourth embodiment. In the spin inductor 103 according to the fourth embodiment, the same components as those in the spin inductor 100 according to the first embodiment are designated by the same reference numerals, and the description thereof will be omitted.

The spin inductor 103 includes the laminate 10, the first terminal 20, the second terminal 30, a magnetic shield 40, an insulating layer 51, and an insulating layer 52. The spin inductor 103 is different from the spin inductor 100 in that the magnetic shield 40 is provided.

The magnetic shield 40 includes, for example, a first yoke 41, a second yoke 42, and a via 43.

The first yoke 41 is separated from the laminate 10 in the z direction. The first yoke 41 is separated from the first ferromagnetic layer 2, the second ferromagnetic layer 3, and the third ferromagnetic layer 5 in the z direction.

For example, the insulating layer 51 is between the laminate 10 and the first yoke 41. The insulating layer 51 is an insulating layer that insulates the laminate 10 and the magnetic shield 40. The insulating layer 51 is, for example, silicon oxide (SiOR), silicon nitride (SiNR), silicon carbide (SiC), chromium nitride, silicon carbonitride (SiCN), silicon oxynitride (SiON), aluminum oxide (Al₂O₃), zirconium oxide (ZrOx), magnesium oxide (MgO), aluminum nitride (AlN), or the like.

The second yoke 42 is separated from the laminate 10 in the z direction. The first yoke 41 and the second yoke 42 sandwich the laminate 10 in the z direction.

For example, the insulating layer 52 is between the laminate 10 and the second yoke 42. The insulating layer 52 is an insulating layer that insulates the laminate 10 and the magnetic shield 40. The insulating layer 52 includes the same material as the insulating layer 51.

The first yoke 41 and the second yoke 42 suppress the laminate 10 from being influenced by an external magnetic field. Further, the first yoke 41 and the second yoke 42 also facilitate orienting the magnetizations of the first ferromagnetic layer 2, the second ferromagnetic layer 3, and the third ferromagnetic layer 5 in the z direction. When the magnetization is strongly oriented in the z direction, the axes of the precession of the magnetization M2 and the magnetization M3 are stabilized, and the spin inductor 103 exhibits a large inductance.

The via 43 connects the first yoke 41 and the second yoke 42. When the first yoke 41 and the second yoke 42 are connected by the via 43, the magnetic flux returns along the magnetic shield 40. As a result, the magnetization M2 and the magnetization M3 are strongly oriented in the z direction, and the spin inductor 103 exhibits a large inductance.

The spin inductor 103 according to the fourth embodiment provides the same effects as the spin inductor 100 according to the first embodiment. In addition, the magnetic shield 40 can reduce the influence of the external magnetic field on the magnetizations M2 and M3. Furthermore, when the magnetic shield 40 is configured as described above, the precession of the magnetization M2 and the magnetization M3 is stabilized, and the spin inductor 103 exhibits a large inductance.

The magnetic shield 40 is not limited to the configurations shown in FIGS. 11 to 13. For example, only either the first yoke 41 or the second yoke 42 may be used. Further, the magnetic shield 40 may also be applied to the spin inductors according to the second embodiment and the third embodiment.

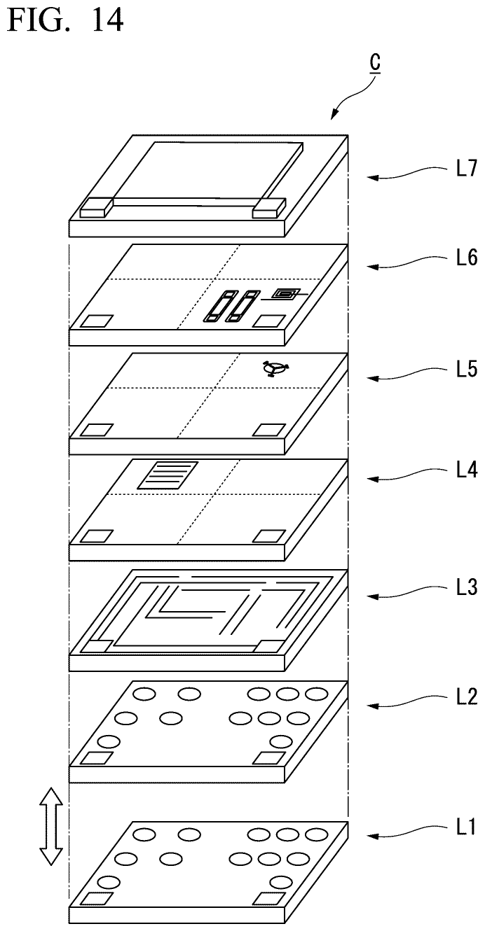

The first to fourth embodiments have been described above, and detailed configurations of the spin inductor have been described. The spin inductor according to the present disclosure is not limited to these exemplary configurations, and various modifications are possible within the scope of the invention. Furthermore, the spin inductor according to the present disclosure can be incorporated into a module for use, for example. FIG. 14 is an application example of the spin inductor according to this embodiment.

In recent years, there has been a study on integrating semiconductor circuits and devices with specific functions, such as memory, into a single chip. The technology of combining semiconductor circuits and devices such as memory on a single chip is called “chiplet” or “heterointegration.” By integrating these functions into a single chip, latency can be reduced, power consumption can be reduced, and costs can be reduced. Even with these technologies, passive components need to be placed around the chip for the function thereof. Therefore, even if the chips are highly integrated, passive components can be a challenge in miniaturizing the module. By incorporating passive components into chiplets and heterointegration, it is expected that the module can be further miniaturized.

The chip C shown in FIG. 14 includes a semiconductor circuit L1, a connection layer L2, a wiring layer L3, a memory layer LA, a sensor layer L5, an LCR (passive component) layer L6, and an all-solid-state thin-film battery layer L7, which are laminated in this order. Although each layer is bonded to form a single chip, spaces are provided between the layers to facilitate understanding in FIG. 14. The spin inductor according to the present disclosure is formed, for example, in the LCR layer L6. The LCR layer L6 may form not only passive components such as inductance, capacitance, and resistance, which are conventional electronic components, but also spin inductors and spin variable capacitances. The LCR layer L6 is connected to other layers by contact vias, and the entire chip C is used as one module. The spin inductor according to the present disclosure can be applied to a device that has a sensor and a power source as shown in FIG. 14 and can autonomously collect information.

### REFERENCE SIGNS LIST

1, 6 Wiring layer
1A First surface
1B Second surface
2 First ferromagnetic layer
3 Second ferromagnetic layer
4 Magnetic coupling layer
5 Third ferromagnetic layer
7 First layer
8 Second layer
10, 11, 12 Laminate
10A First side surface
10B Second side surface
20 First terminal
30 Second terminal
40 Magnetic shield
41 First yoke
42 Second yoke
43 Via
51, 52 Insulating layer
91 Conductive layer
92, 93, 95 Ferromagnetic layer
94 Intermediate layer
10
100, 101, 102, 103 Spin inductor
M2, M3, M5 Magnetization

1. A spin inductor comprising:
a wiring layer;
a first ferromagnetic layer which is in contact with a first surface of the wiring layer; and
a second ferromagnetic layer which is in contact with a second surface of the wiring layer facing the first surface.

2. The spin inductor according to claim 1,
wherein the magnetization of the first ferromagnetic layer is oriented in an opposite direction to the magnetization of the second ferromagnetic layer.

3. The spin inductor according to claim 1, further comprising:
a third ferromagnetic layer and a magnetic coupling layer,
wherein the magnetic coupling layer is between the second ferromagnetic layer and the third ferromagnetic layer.

4. The spin inductor according to claim 3,
wherein the magnetization of the first ferromagnetic layer is oriented in the same direction as the magnetization of the third ferromagnetic layer.

5. The spin inductor according to claim 3,
wherein the third ferromagnetic layer has a film thickness thicker than a film thickness of the second ferromagnetic layer.

6. The spin inductor according to claim 1,
wherein the wiring layer includes a first layer and a second layer.

7. The spin inductor according to claim 6,
wherein a sign of a spin current generated by the first layer is different from a sign of a spin current generated by the second layer.

8. The spin inductor according to claim 6,
wherein the magnetization of the first ferromagnetic layer is oriented in the same direction as the magnetization of the second ferromagnetic layer.

9. The spin inductor according to claim 1, further comprising:
a magnetic shield layer,
wherein the magnetic shield layer is separated from the first ferromagnetic layer and the second ferromagnetic layer in a laminating direction.

10. The spin inductor according to claim 1,
wherein the wiring layer is configured to inject spins into the first ferromagnetic layer and the second ferromagnetic layer, and
wherein the magnetizations of the first ferromagnetic layer and the second ferromagnetic layer are configured to precess by the injected spins.
